(19) United States
(12) Patent Application Publication
(10) Pub. No.: US 2011/0199951 A1
(43) Pub. Date: Aug. 18, 2011

(54) DISCONTINUOUS RECEPTION METHOD AND APPARATUS IN MULTI-COMPONENT CARRIER SYSTEM

(75) Inventors: Ki Bum KWON, Ansan-si (KR); Myung Cheul JUNG, Seoul (KR)

(73) Assignee: PANTECH CO., LTD., Seoul (KR)

(21) Appl. No.: 13/029,991

(22) Filed: Feb. 17, 2011

(30) Foreign Application Priority Data
Feb. 17, 2010 (KR) 10-2010-0014359

(51) Int. Cl. H04W 52/02

(52) U.S. Cl. 370/311

(57) ABSTRACT

An apparatus and a method for performing a Discontinuous Reception (DRX) in a multi-Component Carrier (CC) system are disclosed. The method includes determining whether a condition for an application of a DRX to a first CC is satisfied and, if the condition is satisfied, performing the DRX on the first CC based on DRX configuration information common to the first CC and a reference CC. The on-duration of the DRX applied to the first CC is synchronized with the on-duration of a DRX mode of the reference CC. Although CCs enter the DRX mode at different points of time, the active or inactive times of the DRX modes are synchronized with each other such that the PDCCHs of all the CCs may be detected at the active times of the respective CCs.

This application claims priority from and the benefit under 35 U.S.C. §119(a) of Korean patent application No. 10-2010-0014359, filed on Feb. 17, 2010, the disclosure of which is incorporated herein by reference for all purposes.

### BACKGROUND

1. Field

The following description relates to an apparatus and method for performing discontinuous reception in a multi-component carrier wireless communication system.

2. Discussion of the Background

Wireless communication systems are developing to satisfy user service needs using multiple-component carrier (hereinafter referred to as a ‘CC’).

However, a detailed scheme for how multiple CCs will be operated is not clearly defined. Meanwhile, several techniques regarding a definition for the characteristic of each CC and a scheme for efficiently operating CCs to be defined are being discussed.

In the next-generation communication system, there is a need for a detailed operating scenario for a plurality of CCs and a need for a system operating scheme in which power consumption in the reception apparatus of a wireless communication system is taken into consideration. Furthermore, there is a need for a data transmission and reception scheme for more efficient power consumption of the reception apparatus.

### SUMMARY

Exemplary embodiments of the present invention provide an apparatus and method for discontinuous transmission and reception in a wireless communication system considering activation and deactivation.

Exemplary embodiments of the present invention provide an apparatus and method for signaling the activation and deactivation of a CC in a wireless communication system.

Exemplary embodiments of the present invention provide an apparatus and method for controlling the activation and deactivation of a specific CC based on activation and deactivation signaling in a wireless communication system.

Exemplary embodiments of the present invention provide an apparatus and method for controlling a discontinuous reception (DRX) operation according to the activation or deactivation of at least one CC in a wireless communication system.

Exemplary embodiments of the present invention provide an apparatus and method for receiving data in the DRX operation according to the activation and deactivation of at least one CC in a wireless communication system.

Exemplary embodiments of the present invention provide an apparatus and method for adjusting the DRX operating cycle of other CCs on the basis of a specific CC.

Exemplary embodiments of the present invention provide an apparatus and method for performing DRX on the basis of DRX configuration information which is commonly applied to all CCs.

Additional features of the invention will be set forth in the description which follows, and in part will be apparent from the description, or may be learned by practice of the invention.

An exemplary embodiment provides a method for performing Discontinuous Reception (DRX) by a User Equipment (UE) in a multi-Component Carrier (CC) system, the method including determining whether a condition for an application of a DRX to a first CC is satisfied, and if the condition is satisfied, performing the DRX on the first CC based on DRX configuration information common to the first CC and a reference CC, wherein an on-duration of the DRX applied to the first CC is synchronized with an on-duration of a DRX of the reference CC.

An exemplary embodiment provides an apparatus to perform a DRX in a multi-CC system, the apparatus including a DRX control unit to determine whether a condition for an application of a DRX to a first CC is satisfied and to perform the DRX on the first CC based on DRX configuration information common to the first CC and a reference CC if the condition is satisfied, and a transmission and reception unit to receive the DRX configuration information, wherein the DRX control unit synchronizes an on-duration of the first CC with an on-duration of the reference CC.

An exemplary embodiment provides an apparatus to transmit Component Carrier (CC) activation/deactivation information in a multi-Component Carrier (CC) system, the apparatus including an instruction message generation unit to generate an activation or deactivation instruction message for one or more of a plurality of CCs according to a condition for a DRX operation in a User Equipment (UE); a transmission and reception unit to transmit the generated activation or deactivation instruction message to the UE; a UE mode check unit to check whether a Radio Resource Control (RRC) connection is set up with the UE; an activation CC selection unit to determine a CC to be set as an activation CC from among the plurality of CCs; and a CC set determination unit to determine a set of CCs from the plurality of CCs to be configured by the UE.

An exemplary embodiment provides a method for performing Discontinuous Reception (DRX) in a multi-Component Carrier (CC) system, the method including: checking a Radio Resource Control (RRC) mode of a user equipment (UE); configuring a CC set; transmitting the configured CC set to the UE; transmitting system information for the CC set to the UE; selecting an activation CC according to CC activation requirements; checking a CC operating in the activation mode from the deactivation mode, generating an activation instruction message, and transmitting the activation instruction message to the UE; and checking a CC operating in the deactivation mode from the activation mode, generating a deactivation instruction message, and transmitting the deactivation instruction message to the UE.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 illustrates a CC environment in which a plurality of CCs is used according to an exemplary embodiment.

FIG. 2 is a diagram showing an activation/deactivation scheme for a plurality of CCs according to an exemplary embodiment.

FIG. 3 is a diagram showing a scheme for DRX according to an exemplary embodiment.

FIG. 4 is a diagram showing a DRX mode in which CC activation/deactivation signaling is taken into consideration according to an exemplary embodiment.

FIG. 5 is a diagram showing a DRX mode in which CC activation/deactivation signaling is taken into consideration according to an exemplary embodiment.

FIG. 6 is a flowchart illustrating a method for transmitting CC activation/deactivation instruction messages according to an exemplary embodiment.

FIGS. 7a and 7b are a flowchart illustrating a method for activating a DL CC according to an exemplary embodiment.

FIGS. 8a and 8b are a flowchart illustrating a method for activating a CC according to an exemplary embodiment.

FIG. 9 is a block diagram of a transmission apparatus according to an exemplary embodiment.

FIG. 10 is a block diagram of a reception apparatus according to an exemplary embodiment.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

In describing the elements in this specification, terms, such as first, second, A, B, (a), and (b), may be used. The terms are used to only distinguish one element from the other element, and the essence, sequences, or order of a corresponding element is not restricted by the terms. Furthermore, in the case in which one element is described to be “connected”, “coupled”, or “jointed” to the other element, the one element may be directly connected or coupled to the other element, but it is to be understood that a third element may be “connected”, “coupled”, or “jointed” between the two elements.

In this specification, a wireless communication network is described as a target. Tasks performed in the wireless communication network are performed in a process of a system, for example, a base station, controlling the wireless communication network, controlling the network and transmitting data, but may be performed in a user equipment connected to the corresponding wireless network.

Wireless communication systems are widely deployed in order to provide various communication services, voice and packet data. The wireless communication system includes User Equipments (UEs) and Base Stations (BSs).

In this specification, a UE is a comprehensive concept referring to a user terminal in wireless communication, and it should be interpreted as a concept, including a Mobile Station (MS), a User Terminal (UT), a Subscriber Station (SS), a wireless device in GSM, a UE in WCDMA, LTE, and HSPA, and the like.

In general, a BS or a cell refers to a fixed station communicating with a UE, and it may be a node-B, an evolved Node-B (eNB), a Base Transceiver System (BTS), an access point, a femto BS, a relay, and the like. That is, herein, a BS or cell may be interpreted as a comprehensive meaning to indicate some region covered by a Base Station Controller (BSC) in CDMA and a node B in WCDMA. The BS or cell may include various coverage regions, such as a mega cell, a macro cell, a micro cell, a pico cell, and a femto cell.

In this specification, a UE and an eNB are used as comprehensive meanings (i.e., two subjects of transmission and reception) which are used to implement techniques described in this specification, but not limited to specific terms or words.

Multi-access schemes applied to the wireless communication system are not limited. A variety of multi-access schemes, such as Code Division Multiple Access (CDMA), Time Division Multiple Access (TDMA), Frequency Division Multiple Access (FDMA), Orthogonal Frequency Division Multiple Access (OFDMA), OFDM-FDMA, OFDM-TDMA, OFDM-CDMA, and the like, may be used.

In uplink transmission and downlink transmission, a Time Division Duplex (TDD) method of transmitting data using different times or a Frequency Division Duplex (FDD) method of transmitting data using different frequencies may be used.

Exemplary embodiments of this specification may be applied to resource allocation, such as asynchronous wireless communication, Long Term Evolution (LTE) and LTE-Advanced via GSM, WCDMA, HSPA, and the like, and synchronous wireless communication, CDMA, CDMA-2000, UMB, and the like. Exemplary embodiments in this specification should not be interpreted as being limited or restricted to the field of specific wireless communication, but should be interpreted as including all the technical fields to which this specification can be applied.

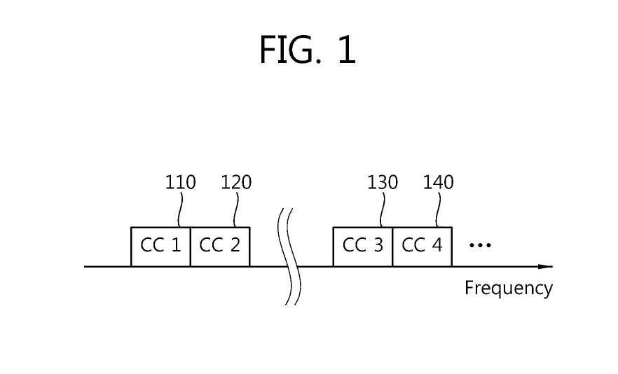

FIG. 1 illustrates a CC environment in which a plurality of CCs is used according an exemplary embodiment. Referring to FIG. 1, an LTE-Advanced (LTE-A) system is used as an example of the wireless communication system. The LTE-A system is a scheme for extending bandwidth to satisfy system requirements for a high data transmission rate. The LTE-A system defines and uses a plurality of Component Carriers (CCs) i.e., unit carrier. A component carrier is indicated by a CC and may be indicated by a CC0, a CC1, etc. according to its index. It is to be noted that the index of a CC does not necessarily comply with the sequence of the CC or the position of a frequency band of the CC. For example, in an LTE-A system, one CC may have a bandwidth of up to 20 MHz, and resources may be allocated to one CC within 20 MHz according to relevant service.

The use of a carrier aggregation (CA) in which a plurality of CCs are aggregated and used as one system band may be defined. Accordingly, in the next-generation communication system, quality of service is supported by extending the bandwidth to 100 MHz. Here, frequency bands that can be determined (i.e., allocated) by respective CCs may be contiguous or noncontiguous according to the scheduling of an actual CA.

FIG. 1 shows a first CC (CC1) 110, a second CC (CC2) 120, a third CC (CC3) 130, and a fourth CC (CC4) 140. In the CCs, uplink or downlink may be differently allocated according to a scheduler, or a same uplink and downlink may be allocated and used.

An operating method for a plurality of CCs may be determined by taking the following factors into consideration. First, the operating method may be influenced by physical CC characteristics, which may be defined by the propagation characteristic of each CC and the hardware performance of a UE. Furthermore, the operating method may be influenced by logical CC characteristics, such as the definition of the role of each CC and the establishment of a relationship between a downlink (hereinafter referred to as ‘DL’) and uplink (hereinafter referred to as ‘UL’).

According to aspects of the present invention, the activation and deactivation of a Downlink Component Carrier (hereinafter referred to as a ‘DL CC’) is defined by taking the characteristic of each CC into consideration.

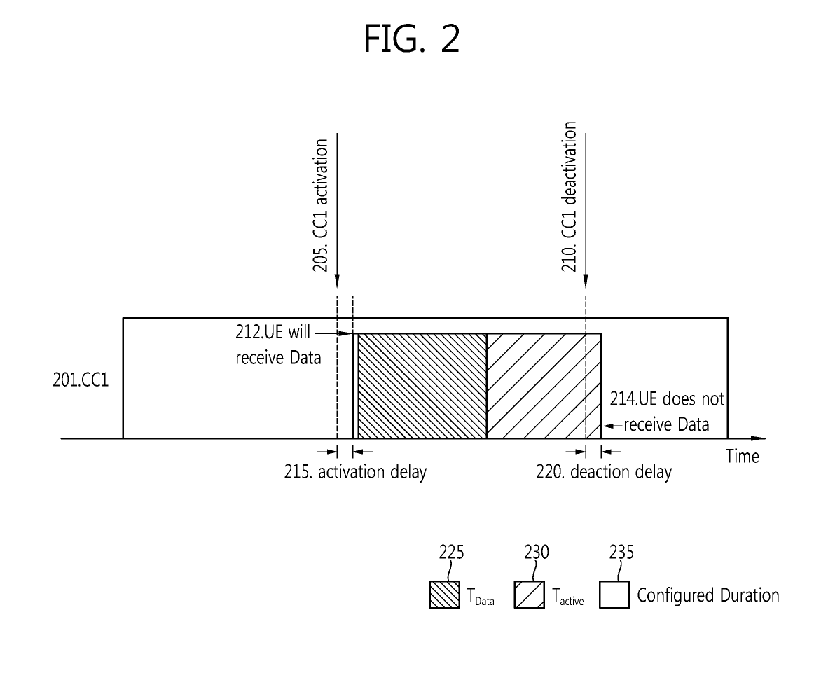

FIG. 2 is a diagram showing an activation/deactivation scheme for CCs according to an exemplary embodiment.

As shown in FIG. 2, a UE capable of monitoring a CC1 201 can receive a message for the activation of the CC1 205. After a lapse of activation delay 215, the CC1 is activated. If the UE receives a message for deactivation 210, the CC1 is deactivated after a lapse of deactivation delay 220.

At a point of time 212, the UE may receive data through the activated CC1 in the active period 230. In the deactivation mode 214, the UE cannot receive data (for example, Physical Downlink Control Channels (PDCCHs) and Physical Downlink Shared Channels (PDSCHs)). For example, the UE operating in the activation mode or active period 230 during the configured duration 235 can receive data during the period 225. In the case in which a deactivation instruction message is not received during a period in which data is not received, the activation mode can be sustained, for example, as in period 230.

Here, the activation delay 215 and the deactivation delay 220 may be variable according to the performance of a UE, the performance of a network, a geographical location at which a UE is placed, and a channel condition. Furthermore, the UE may sustain the activation mode or active period 230 until the UE receives the message for the deactivation 210.

As described above, the activation and deactivation of a DL CC is one of the schemes for reducing power consumption of a UE. A wireless communication system according to aspects of the present invention can operate activation and deactivation for DL CCs, configured in a UE, using the activation and deactivation method shown in FIG. 2.

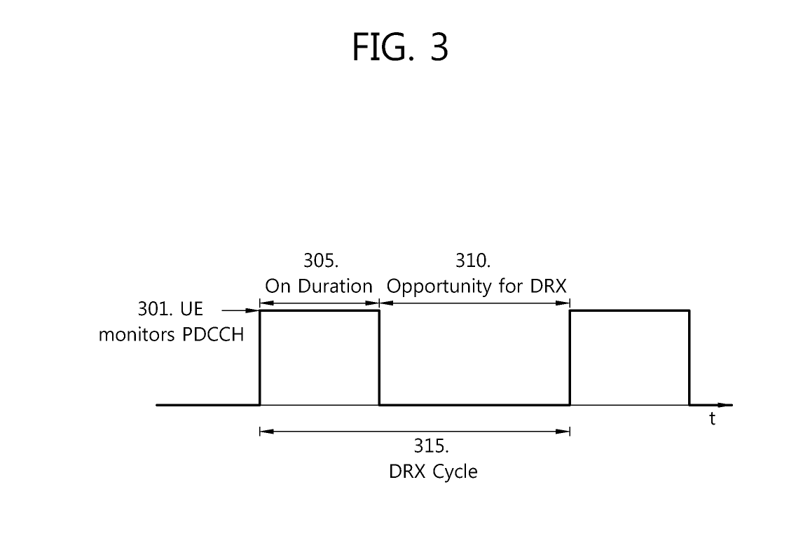

FIG. 3 is a diagram showing a scheme for DRX according to an exemplary embodiment. Referring to FIG. 3, a UE may use a DRX (Discontinuous Reception) mode in order to reduce power.

For example, if the DRX mode is defined in a UE, the UE may permit a period in which physical control channels, such as PDCCHs, need not to be monitored.

If the DRX mode is not defined in a UE, the UE continuously monitors physical control channels. A mode in which physical control channels have to be continuously monitored is called a Normal Reception (hereinafter referred to as ‘NRX’) mode.

In relation to the DRX mode, in a wireless communication system operating a single band, an eNB transmits information on the DRX mode to an UE in advance using system information. The UE independently performs the DRX mode on the basis of the received DRX-related information without receiving additional information from the eNB.

Referring to FIG. 3, a DRX cycle includes an on-duration 305 in which the UE monitors the physical control channels and an opportunity period 310 for DRX in which physical control channels need not to be monitored. A period in which a UE monitors physical control channels within a period where the physical control channels are transmitted may be referred to as the on-duration 305.

Meanwhile, the DRX cycle may be repeated in a short cycle and a long cycle. The DRX mode may be operated in the form of the short cycle, but may be changed to the long cycle, for example, after the short cycle is repeated for a predetermined period or more.

A UE may perform the DRX mode using at least one of the following timers.

1-1) DRX-inactivity timer:

A DRX-inactivity timer is operated if a PDCCH is not received after a PDCCH related to UE data transmission of DL or UL is successfully received. If the timer expires, an active time may be terminated, and the DRX mode may be started.

1-2) DRX-Retransmission Timer:

A DRX-retransmission timer counts the number of PDCCH subframes until a point of time at which an eNB retransmits error-reported data. If there is an error in data transmitted in downlink, a UE reports error of an eNB. The eNB retransmits data by taking the number of times of retransmission so far and a point of time of retransmission into consideration. Accordingly, the UE may not continuously maintain the data reception up to a point of time at which the data retransmitted by the eNB is received until the timer expires.

1-3) DRXShortCycle Timer:

A DRXShortCycle timer counts the number of PDCCH subframes which continuously sets a short cycle.

1-4) DRXStartOffset:

A DRXStartOffset is an offset value of a subframe to start a DRX cycle

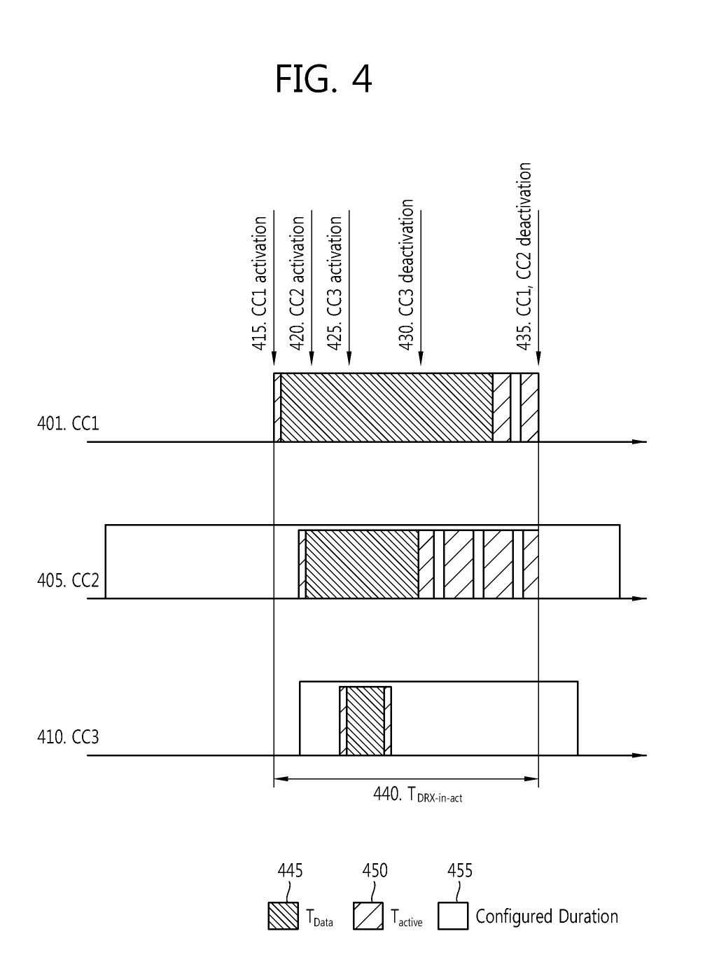

FIG. 4 is a diagram showing the DRX mode in which CC activation/deactivation signaling is taken into consideration according to an exemplary embodiment. FIG. 4 illustrates a case in which CCs configured in a UE are operated in the DRX mode if the CCs are activated.

Referring to FIG. 4, three CCs: a CC1 401, a CC2 405, and a CC3 410 are configured in a UE. Each of the CC1 401, CC2 405, and CC3 410 are support the DRX mode. In particular, if the DRX mode is to be applied, a CC may be activated. According to an exemplary embodiment, at least one of the following assumptions may be applied but aspects are not limited to the following.

2-1) The UE is configuring at least one CC.

2-2) The CC1 is always configured.

2-3) Configuration for CCs other than the CC1 and configuration release signals or messages are transmitted only through the CC1.

2-4) Activation/deactivation signaling for CCs other than the CC1 may be transmitted through not only the CC1, but also each of the CCs.

Configuring a CC refers to an eNB allowing a UE to use the CC and provides the UE with information necessary to use the CC. Here, a method of a UE configuring the CC includes an eNB recognizing the frequency band, a function, and version of a CC which can be supported in the hardware of the UE and transmitting a message informing the permission of use of the CC to the UE. Furthermore, the information necessary for the UE to configure the CC may include system information on the CC.

The system information may be sent from an eNB to a UE through a broadcasting channel or may be transferred in the form of control information. The form of the control information may be an L1 signaling, such as a PDCCH, an L2 signaling or message, such as a Medium Access Control (MAC) element, or an L3 message, such as a Radio Resource Control (RRC) signaling or message.

Releasing the configuration of a CC refers to an eNB withdrawing permission that a UE may use the CC. The eNB transmits a message, informing the withdrawal of the permission to use the CC to the UE. Criteria by which the eNB determines a CC for withdrawing the permission of usage may include UE measurement information in the CC, a change of available frequency resources in a UE, and the like.

The DL CC configuration release message may be sent in the form of control information. The form of the control information may become an L1 signaling, such as a PDCCH, an L2 signaling or message, such as an MAC element, or an L3 message, such as an RRC signaling or message.

In FIG. 4, a point of time at which a special signaling or message is transmitted from an eNB to a UE has a different characteristic according to a type of a transferred message. Accordingly, a configured duration period 455 of FIG. 4 indicates a period from the configuration of a CC until the release of the configuration of the CC.

Activating a CC refers to a UE being allowed to receive a CC, configured by an eNB so that the CC can be used, through signaling or other methods in the case in which a PDCCH and a PDSCH exist. That is, if the UE is configured with one or more CCs, the network may activate and deactivate the configured CCs. The UE shall monitor the PDCCH of a activated CC and shall react any downlink assignments or process uplink grants associated to a activated CC. Herein the channel for the downlink assignments is called the PDSCH.

Methods for the UE activating the CC may include a method of setting an RF and a baseband modem, which may be set not to be used, so that the RF and baseband modem can be used, a method for activating a signal reception function for a frequency band in which the CC is configured through a similar operation, and the like.

In FIG. 4, an eNB transmits activation instruction messages 415, 420, and 425 to a UE so that the UE can activate a DL CC. The activation instruction message may be an L1 signaling, such as a PDCCH, an L2 signaling or message, such as an MAC element, or an L3 message, such as an RRC signaling or message. However, aspects are not limited thereto such that the UE may activate the DL CC without receiving the activation instruction messages 415, 420, and 425 from the eNB.

If the UE activates a DL CC and which DL CC the UE activates may be configured on the basis of pieces of information other than a DL activation instruction message, from among pieces of information which are previously received from system information and control information, such as a PDCCH.

Meanwhile, an example of a case in which a UE activates a DL CC on the basis of information previously received from broadcasting information, such as the system information, without an activation instruction message from an eNB is described below. A UE may store time/frequency resource information on system information, transmitted by an eNB at a fixed point of time, from system information in its internal memory and receive the system information using the corresponding information by activating each DL CC. The system information includes time/frequency resource information on system information, which may be dynamically transmitted.

Accordingly, the UE can know time/frequency resource information that the fixed/dynamic system information transmitted in advance. Thus, the UE activates the DL CC within a predetermined range on the basis of the point of time.

An example of a case in which a UE activates a DL CC on the basis of information previously received from the control information, such as a PDCCH, without an activation instruction message from an eNB is described below. That is, the DL CC, a PCC is always activated for the UE.

The eNB transmits UL resource allocation information to the UE using the existing activated CC. The UE receives the UL resource allocation information and then transmits data through the UL. Acknowledgement (ACK)/non-acknowledgement (NACK) information on the transmitted data is transmitted through the DL CC that is connection-set to the corresponding UL. If the DL CC is deactivated, the ACK/NACK information cannot be received. Accordingly, the DL CC may be activated in order to receive the ACK/NACK information. To this end, the UE can know a point of time at which the ACK/NACK information is to be received from the eNB on the basis of a point of time at which the data is transmitted through the UL. Accordingly, the UE activates the DL CC within a predetermined range on the basis of the point of time.

Deactivating a CC refers to that, in the case where an eNB does not transmit data, such as a PDCCH and a PDSCH, to a UE through the CC, the CC configured to be used is not received through signaling or other methods although a PDCCH and a PDSCH may exist. That is, if the UE is configured with one or more CCs, the network may activate and deactivate the configured CCs. The UE shall not monitor the PDCCH of a deactivated CC and shall not receive any downlink assignments or uplink grants associated to a deactivated CC. Herein the channel for the downlink assignments is called the PDSCH. A method for a UE deactivating the CC may include a method for setting an RF and a baseband modem, which may be set to be used, so that the RF and baseband modem cannot be used, a method of deactivating a signal reception function for a frequency band in which the CC is configured through a similar operation, and the like.

Deactivation instruction messages 430 and 435 by which an eNB instructs a UE to deactivate a DL CC may be an L1 signaling, such as a PDCCH, an L2 signaling or message, such as an MAC element, or an L3 message, such as an RRC signaling or message. The UE may deactivate the DL CC without receiving the activation instruction message from the eNB. Here, the UE deactivates a DL CC that may be configured on the basis of pieces of information other than a DL activation instruction message, from among pieces of information which are previously received from system information and control information, such as a PDCCH.

The operations of an eNB and a UE in the example of FIG. 4 are described below.

The UE activates CCs in order to receive physical channel control information, such as a PDCCH, or data information, such as a PDSCH. In FIG. 4, the UE receives from the eNB signaling, i.e., activation instruction message 415, instructing to activate the CC1 401 and activates the CC1 401.

Accordingly, the UE can receive data sent by the eNB through the CC1 401. If conditions necessary to use an additional CC are satisfied in order to transmit the data, the UE receives activation signaling, i.e., activation instruction message 420, for the additional CC from the eNB through the CC1 401 and activates the CC2 405 in response to the activation instruction message 420.

The UE may receive from the eNB signaling or a message, i.e. activation instruction message 425, instructing the UE to configure the CC3 410 and configure the CC3 410 in response to the activation instruction message 425, at the same time.

Here, the conditions necessary to use the additional CC in order to transmit the data may include conditions set by the QoS of a corresponding traffic, a change of QoS required by a UE, a load distribution policy in a network, a scheduler policy of an eNB, and the like. If at least one of the conditions is satisfied, the use of the additional CC can be defined. Furthermore, the use of the additional CC may be triggered by a UE, an eNB, or a network.

Further, for example, if there is no data to be transmitted from the eNB to the UE through the CC3 410, i.e., there is no data to be sent through the CC3 410 later, the eNB may deactivate the CC3 410 by sending the deactivation instruction message 430. Meanwhile, if there is data to be transmitted by the eNB through the CC2 405, but there is a possibility that data may be immediately transmitted through the CC2 405, the UE need not deactivate the CC3 410.

Accordingly, the UE starts the DRX mode 440 on the basis of predetermined DRX configuration information with respect to CCs which are configured and activated but not used to receive data at that point.

In an exemplary embodiment, the predetermined DRX configuration information includes parameters common to all the CCs. The DRX configuration information, including parameters common to all the CCs, is referred to as common DRX configuration information. For example, in the common DRX configuration information, a timer length, an active time, a DRX cycle, and the like in the DRX mode are the same in all the CCs. Here, the active time may also be referred to as an on-duration.

Assuming that each CC enters the DRX mode on the basis of the common DRX configuration information, points of time at which each CC enters the DRX mode may be different. For example, in FIG. 4, the CC2 405 enters the DRX mode first as indicated by the configured duration 455 of the CC2 405 and the CC1 401 then enters the DRX mode. Accordingly, if the CC2 405 first enters the DRX mode, a UE may adjust the DRX cycle or active time of the CC1 401, which secondarily enters the DRX mode, so that the DRX cycle or active time of the CC1 401 is identical with the DRX cycle or the active time of the CC2 405. That is, the UE may slightly move the first active time of the CC1 401 so that the first active time of the CC1 401 equals to the second active time of the CC2 405 to synchronize the active times of all the CCs, which are configured and activated for the UE.

In order for all the CCs to be synchronized and to be operated in the DRX mode, a CC that is a reference of the synchronization may be determined. The CC is called a reference CC. In the example of FIG. 4, the CC2 405, entering the DRX mode first is determined to be a reference CC; however, aspects are not limited thereto such that another CC may be the reference CC. An eNB may directly determine a reference CC (for example, a PCC) and inform an UE of the reference CC, or a CC determined by an UE may become a reference CC. For example, assuming that the CC2 is a reference CC, if the CC1 and the CC3 enter the DRX mode, the DRX cycles of the CC1 and the CC3 are adjusted so that they are synchronized with the active time of the CC2. Thus, the CC1, the CC2, and the CC3 may be activated at the same point of time and may be deactivated at the same point of time.

If the active time or inactive time of DRX is synchronized as described above, although CCs enter the DRX mode at different points of time, PDCCHs of all the CCs may be detected at the active time for each CC. Accordingly, the power consumption of a UE can be reduced.

According to an exemplary embodiment, the predetermined DRX configuration information may include dedicated parameters for each CC. In this case, a UE within a wireless communication system operating a plurality of CCs can independently perform the DRX mode for every CC.

In summary, the DRX mode may be operated based on one of the following methods; however, aspects are not limited to the following.

1. The DRX mode may be operated according to DRX information on each CC after independent DRX configuration information for each CC is received.

2. The DRX mode may be operated after independent DRX configuration information on each CC is received and the DRX mode of a reference CC set for every UE is then applied to CCs complying with predetermined criteria.

3. The DRX mode may be operated including an independent operation for every CC after DRX configuration information is received according to a characteristic set for every CC.

4. The DRX mode may be operated after DRX configuration information is received according to a characteristic set for every CC and the DRX mode of a reference CC set for every UE is then applied to CCs complying with predetermined criteria.

5. The DRX mode may be operated including an operation of synchronizing the active times so that all the CCs have the same active time as a reference CC after the same common DRX configuration information for all the CCs is received.

In FIG. 4, the CCs 401 and 405 may operate in the DRX mode to activate CCs according to, for example, the second, fourth, and fifth methods and may perform the same DRX mode.

In other words, if there is at least one activated CC and data is not received in the DRX period T_DRX-in-act 440, the UE may perform the DRX mode on the activated CC.

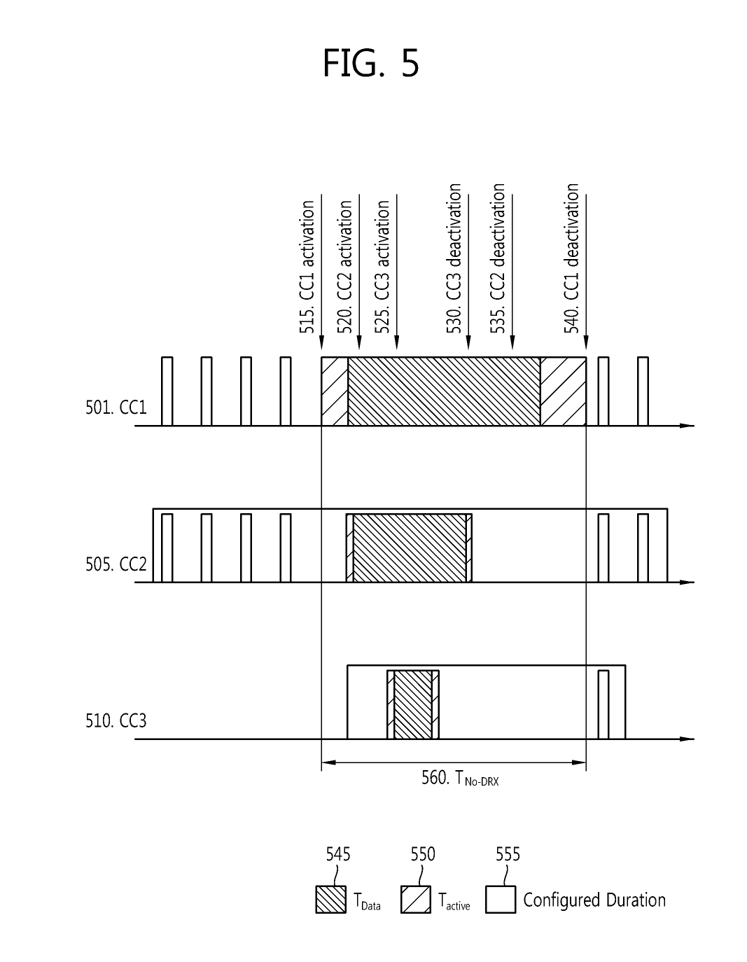

FIG. 5 is a diagram showing the DRX mode in which CC activation/deactivation signaling is taken into consideration according to an exemplary embodiment. FIG. 5 corresponds to a case in which a CC configured in a UE is operated in the DRX mode while the CC is deactivated.

Referring to FIG. 5, three CCs: a CC1 501, a CC2 505, and a CC3 510 are configured for the UE, and the DRX mode in which CC activation/deactivation signaling in the UE is taken into consideration is described below. According to an exemplary embodiment, at least one of the following assumptions may be applied but aspects are not limited to the following.

3-1) The UE is configuring at least one CC.

3-2) The CC1 is always configured.

3-3) Configuration and configuration release signals or messages for CCs other than the CC1 are transmitted through the CC1.

3-4) If there is no activated CC, activation/deactivation signals for a CC may be transmitted through each CC.

3-5) If there is an activated CC, activation/deactivation signals for CCs other than the activated CC are transmitted only through the activated CC.

In FIG. 5, the CC1 501 is first activated, and activation/deactivation signals for all CCs are received through the CC1 501.

As an example of a definition for the terms suggested in the above assumption, operations related to the configuration and release of a DL CC and the transmission of control information related to the configuration and release of the DL CC may be similar to those described with reference to FIG. 4, especially, activation/deactivation can be defined with same ways mentioned at FIG. 4, and a detailed description thereof is omitted. Further, the assumptions and the transmission of information described with reference to FIG. 4 may be applied to FIG. 5.

In FIG. 5, a point of time at which a special signaling or message is transmitted from an eNB to a UE has a different characteristic according to the type of a transferred message. A configured duration 555 of FIG. 5 indicates a period from the configuration of a corresponding CC until the release of the configuration of the CC.

An eNB transmits activation instruction messages 515, 520, and 525 to a UE so that the UE can activate a DL CC. The activation instruction message may be an L1 signaling, such as a PDCCH, an L2 signaling or message, such as an MAC element, or an L3 message, such as an RRC signaling or message. However, aspects are not limited thereto such that the UE may activate the DL CC without receiving the activation instruction message from the eNB. If the UE activates a DL CC and which DL CC the UE activates may be set on the basis of pieces of information other than a DL activation instruction message, from among pieces of information which are previously received from system information and control information, such as a PDCCH.

An example of a case in which a UE activates a DL CC on the basis of information previously received from broadcasting information, such as the system information, without an activation instruction message from an eNB is described below.

A UE may store time/frequency resource information on system information, transmitted by an eNB at a fixed point of time, from system information in its internal memory and receive the system information using the corresponding information by activating each DL CC. The system information includes time/frequency resource information on system information, which may be dynamically transmitted.

Accordingly, the UE can know time/frequency resource information that the fixed/dynamic system information transmitted in advance. Thus, the UE activates the DL CC within a predetermined range on the basis of the point of time.

An example of a case in which a UE activates a DL CC on the basis of information previously received from the control information, such as a PDCCH, without an activation instruction message from an eNB is described below.

The eNB transmits UL resource allocation information to the UE using the existing activated CC. The UE receives the UL resource allocation information and then transmits data through the UL. ACK/NACK information on the transmitted data is transmitted through the DL CC that is connection-set to the corresponding UL. If the DL CC is deactivated, the ACK/NACK information cannot be received. Accordingly, the DL CC may be activated in order to receive the ACK/NACK information. To this end, the UE can know a point of time at which the ACK/NACK information is to be received from the eNB on the basis of a point of time at which the data is transmitted through the UL. Accordingly, the UE activates the DL CC within a predetermined range on the basis of the point of time.

Meanwhile, “deactivation” refers to that a UE may not monitor a PDCCH and react to a PDSCH.

A method for a UE deactivating the DL CC may include a method for setting an RF and a baseband modem, which may be set to be used, so that the RF and baseband modem cannot be used, a method of deactivating a signal reception function for a frequency band in which the DL CC is configured through a similar operation, and the like.

Deactivation instruction messages 530, 535, and 540 by which an eNB instructs a UE to deactivate a DL CC may be an L1 signaling, such as a PDCCH, an L2 signaling or message, such as an MAC element, or an L3 message, such as an RRC signaling or message. The UE may deactivate the DL CC without receiving the activation instruction message from the eNB. Here, if the UE deactivates a DL CC that may be set on the basis of pieces of information other than a DL activation instruction message, from among pieces of information which are previously received from system information and control information, such as a PDCCH.

The operations of an eNB and a UE in the example of FIG. 5 are described below.

The UE activates CCs in order to receive physical channel control information, such as a PDCCH, or data information, such as a PDSCH. In FIG. 5, if at least one CC is activated, the UE does not perform the DRX mode during the corresponding DRX stop period T_no_DRX 560. In the example of FIG. 5, if a UE is configured, but there is no activated CC, the UE may perform the DRX mode on configured CCs.

A UE within a wireless communication system operating a plurality of CCs may perform an independent DRX mode for every CC. Accordingly, the DRX mode may be operated based on one of the following methods; however, aspects are not limited to the following.

1. The DRX mode may be operated according to DRX information on each CC after independent DRX configuration information for each CC is received.

2. The DRX mode may be operated after independent DRX configuration information on each CC is received and the DRX mode of a reference CC set for every UE is then applied to CCs complying with predetermined criteria.

3. The DRX mode may be operated including an independent operation for every CC after DRX configuration information is received according to a characteristic set for every CC.

4. The DRX mode may be operated after DRX configuration information is received according to a characteristic set for every CC and the DRX mode of a reference CC set for every UE is then applied to CCs complying with predetermined criteria.

5. The DRX mode may be operated including an operation of synchronizing the active times so that all the CCs have the same active time as a reference CC after the same common DRX configuration information for all the CCs is received.

In FIG. 5, the CCs 501, 505, and 510 may be operated in the DRX mode to activate CCs according to, for example, the second, fourth, and fifth methods such that there is no activated CC within a UE in the DRX stop period T_no_DRX 560 and a case in which the CCs 501, 505, and 510 comply with the same common DRX configuration information.

The UE receives an activation instruction messages 515 instructing to the UE to monitor the CC1 501 from the eNB during the DRX mode and activates the CC1 501. Next, the UE receives data, transmitted by the eNB, through the CC1 501.

Meanwhile, if conditions necessary to receive an additional CC in order to transmit the data are satisfied, the UE receives an activation instruction message 520 for the additional CC2 505 from the eNB through the CC1 501 and activates the CC2 505. Further, the UE may receive an activation instruction message 525 instructing the UE to configure the CC3 510 from the eNB and may configure the CC3 510.

The conditions necessary to use the additional CC in order to transmit the data may include conditions set by the QoS of a corresponding traffic, a change of QoS required by a UE, a load distribution policy in a network, a scheduler policy of an eNB, and the like. If at least one of the conditions is satisfied, the use of the additional CC may be triggered by a UE, an eNB, or a network.

Further, for example, if there is no data to be transmitted to the UE through the CC3 510 and also there is no data to be transmitted later through the CC3 510, the eNB may deactivate the CC3 510 by sending a deactivation instruction message 530.

If all the activated CCs are deactivated, the UE starts the DRX mode for configured CCs on the basis of predetermined DRX-related information.

In other words, the UE may not perform the DRX mode if there is at least one activated CC in a DRX stop period T_no_DRX 560. Further, the UE may perform the DRX mode if all the CCs are in the deactivation mode in the DRX stop period T_no_DRX 560.

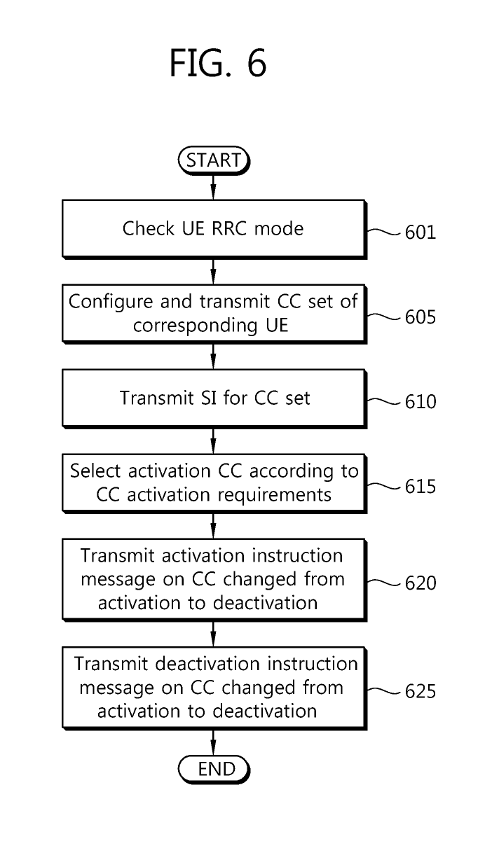

FIG. 6 is a flowchart illustrating a method for transmitting CC activation/deactivation instruction messages according to an exemplary embodiment of the present invention.

Referring to FIG. 6, the method for transmitting activation/deactivation instruction messages may include an eNB generating an activation or deactivation message for one or more of a plurality of CCs by taking conditions for the DRX operation in a UE and the data transmission rate (QoS) of the UE into consideration and a process of the eNB transmitting the generated activation or deactivation message to the UE. The method may include the following detailed processes; however, aspects are not limited thereto.

In operation 601, the eNB checks a Radio Resource Control (RRC) mode of the UE.

If an RRC connection mode of the UE is an idle mode or if an RRC connection may be configured, the eNB cannot define and transmit a CC set for the UE. In this case, the eNB selects at least one CC through which the RRC connection will be performed configures CC set information, and performs the RRC connection.

Meanwhile, a scheme for selecting at least one CC through which an RRC connection may be performed according to at least one of the following; however, aspects are not limited thereto.

A UE may select a CC most appropriate to attempt the RRC connection on the basis of measured information.

The RRC connection may be attempted using information which is stored in the internal memory of a UE and is fixedly set or stored in a system.

An eNB may attempt the RRC connection on the basis of information transmitted to a UE through system information.

The RRC connection may be attempted through corresponding CCs on the basis of system information on valid CCs which are stored in the internal memory of a UE.

If the RRC connection is completed through one of the above or other schemes, the RRC connection mode between the eNB and the UE becomes an RRC_connected mode, and the eNB proceeds to operation 605.

In operation 605, the eNB may permit the UE to use a plurality of CCs according to the hardware performance of the UE and available frequency resources of the eNB and may define a plurality of the CCs as a CC set.

That is, if the RRC connection mode of the UE is the RRC_connected mode, the UE is in the state in which it can perform transmission and reception for the RRC connection using at least one DL and UL CC. The DL CC used upon RRC connection is activated until it is deactivated by a deactivation message or other condition.

The following conditions for defining a CC set may be used according to aspects of the present invention; however, the conditions are not limited to the following such that other conditions may be applied.

a) Conditions on the performance of hardware and the construction of an apparatus: the number of antennas, the range of a reception frequency, the capacity of memory, the number of maximum operating clocks, and the like.

b) The QoS requirements of an application program: VoIP, video streaming service, file transmission, web surfing, and the like.

c) Others: the amount of power consumption, user location information, a shadow region, a frequency selective channel, and the like.

Accordingly, the eNB transmits information on the CC set, defined according to the above conditions, to the UE.

Meanwhile, the CC set information may include the ID of the corresponding CC, index information on each CC, and offset information to indicate other CCs on the basis of at least one CC, which are included in the CC set. The CC set information may also include set ID information to distinguish CC sets, each including at least one CC. According to an exemplary embodiment, in a method for transmitting and receiving the CC set information, the eNB may transmit an RRC reconfiguration message, including the CC set information, to the UE. However, aspects are not limited thereto such that the eNB may transmit the RRC reconfiguration message, including the CC set information, to the UE using other messages.

In operation 610, the eNB transmits system information (SI) on the CCs of the CC set to the UE on the basis of the CC set information. The system information may include information on the center frequency of each CC, information on the entire frequency band of each CC, information on the size of an available frequency, information on the frame configuration of each CC, and a random access procedure, and the like. The system information may be sent through a broadcast channel.

If a CC through which system information cannot be sent, for example, an Extension Component Carrier (hereinafter referred to as an ‘ECC’) exists from among the CCs of a CC set, the system information of the ECC may be converted into a CC from which the system information can be received or converted in the form of control information of a CC through which the system information can be received. However, aspects are not limited thereto such that the transmission of the system information may be performed without receiving the system information on the ECC.

In operation 615, the eNB selects an activation CC for the UE according to the activation mode of the CC set.

In operation 620, the eNB checks a CC, operating in the activation mode from the deactivation mode, generates an activation instruction message, and transmits the activation instruction message to the UE.

In operation 625, the eNB checks a CC, operating in the deactivation mode from the activation mode, generates a deactivation instruction message, and transmits the deactivation instruction message to the UE.

Operations 620 and 625 may be set and performed at a same time. However, aspects are not limited thereto such that the operation 625 may be first performed, and operation 620 may be then performed and vice versa.

The activation/deactivation instruction messages may be transmitted through an L1 signaling, such as a physical control channel, an L2 signaling or message, such as an MAC element, or an L3 message, such as an RRC message.

The activation/deactivation instruction messages may be represented by 1 bit in each CC. The activation/deactivation instruction messages may be represented by a piece of set information by checking whether each CC is activated or deactivated. For example, in the case in which a CC1 and a CC3 are in the activation mode and a CC2 is in the deactivation mode, the set information may represent the CC1 and the CC3, i.e., activated CCs. Further, whether a CC is activated may be represented using the existing signaling, for example, according to control information exists in a physical channel, such as a PDCCH, without using a specific activation instruction message. Herein, the activation instruction message is used as the same meaning as an activation message, and the deactivation instruction message is used as the same meaning as a deactivation message.

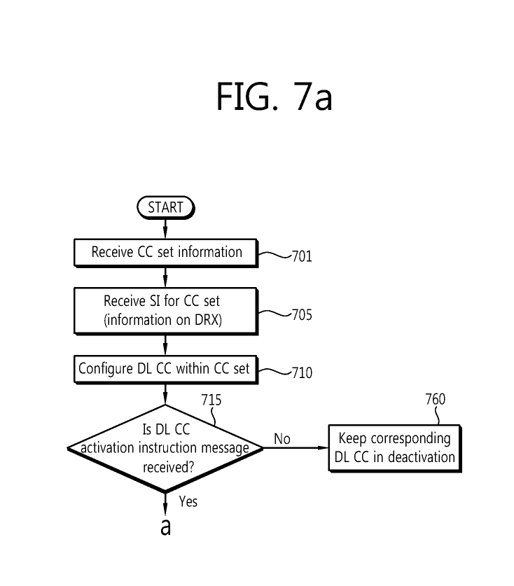

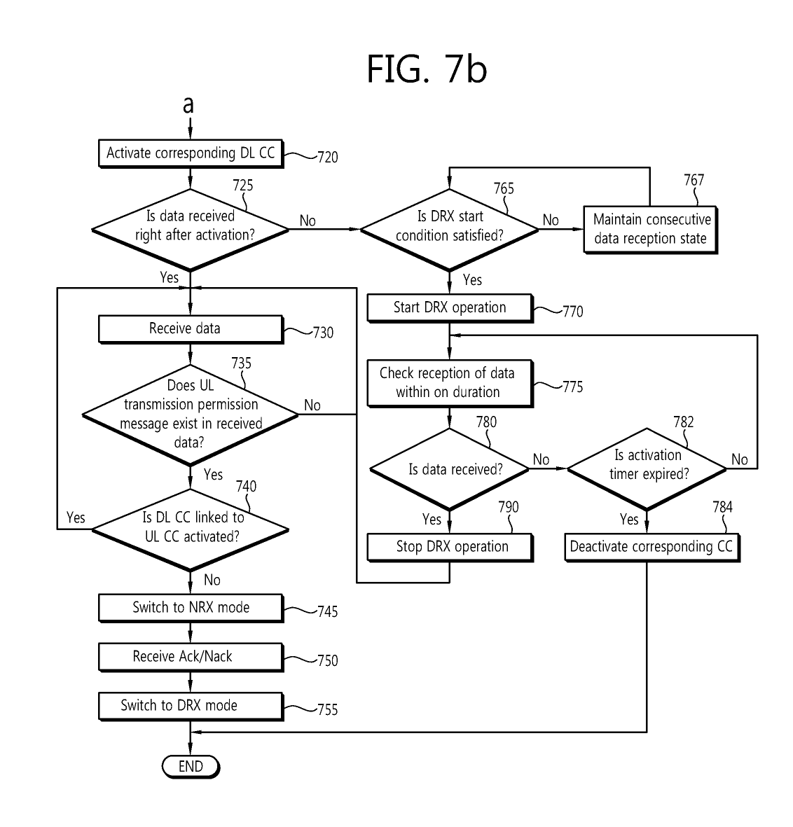

FIGS. 7a and 7b are a flowchart illustrating a method for activating a DL CC according to an exemplary embodiment. The method of FIGS. 7a and 7b correspond to a case in which a UE operates in the DRX mode on an activated CC.

Referring to FIG. 7a and FIG. 7b, a DRX mode method in which the activation mode of a CC is taken into consideration may include a process of a UE receiving an activation message or a deactivation message for at least one CC and a process of the UE performing the DRX operation in at least one CC operating in an activation mode on the basis of the activation message or the deactivation message. The DRX mode method may include the following; however, aspects are not limited thereto.

Referring to FIG. 7a and FIG. 7b, in operation 701, the UE receives information on a plurality of CCs permitted or allocated to the UE from an eNB according to the performance of hardware of the UE and the construction of an apparatus thereof, the QoS requirements of an application program, and the like. A plurality of the allocated CCs may be defined as one CC set.

Here, the RRC connection mode between the eNB and the UE is the RRC_connected mode. That is, the UE is in a state in which the UE can perform transmission and reception for the RRC connection using at least one DL and UL CC. Meanwhile, the DL CC used upon the RRC connection is activated until the DL CC is deactivated by a deactivation message or other conditions.

Information on a CC set of the UE may be sent to the UE through an RRC message. Other messages may be used to transmit the CC set information to the UE. The following conditions for defining a CC set may be used according to aspects of the present invention; however, the conditions are not limited to the following such that other conditions may be applied.

a-1) Conditions on the performance of hardware and the construction of an apparatus: the number of antennas, the range of a reception frequency, the capacity of memory, the number of maximum operating clocks, and the like.

a-2) The QoS requirements of an application program: VoIP, video streaming service, file transmission, web surfing, and the like.

a-3) Others: the amount of power consumption, user location information, a shadow region, a frequency selective channel, and the like.

Meanwhile, if the RRC connection mode between the eNB and the UE is the idle mode or if the RRC_connected mode may be reset, the eNB may not define a CC set for the UE and transmit the CC set. Accordingly, the eNB selects at least one CC on which the RRC connection will be performed by selecting one of the following methods and configures CC set information; however, aspects are not limited hereto such that other methods may be used to select the CC on which the RRC connection will be performed.

b-1) A method for selecting a CC most appropriate to attempt the RRC connection on the basis of measured information.

b-2) A method using information stored in the internal memory of the UE and fixedly set or stored in a system.

b-3) A method using information transmitted from the eNB to the UE through system information.

b-4) A method using system information on valid CCs stored in the internal memory of the UE.

If the RRC connection is completed and the RRC connection mode between the eNB and the UE becomes the RRC_connected mode, operation 701 may be performed.

The UE receives system information (SI) about CCs within the CC set other than CCs used for setting the RRC connection on the basis of the received CC set information in operation 705. The system information includes information related to the DRX mode.

If there is a CC through which system information cannot be sent from among the CCs of the CC set, one of the following schemes may be selected and a procedure may be performed based on the selected scheme; however, aspects are not limited hereto such a different scheme may be applied. The CC may include an ECC (extension component carrier) or other CC type.

c-1) A scheme for receiving information, transmitted in a system information transmission format, through a CC from which system information can be received.

c-2) A scheme for receiving system information, converted into a control information form, through a CC from which control information can be received.

The UE configures each of the CCs in order to receive information through the DL CCs of the CC set on the basis of the received system information in operation 710. After the configuration is completed, the UE sets the corresponding CC in the deactivation mode.

The UE determines whether a DL CC activation instruction message is received in operation 715. If, as a result of the determination, the activation message for a corresponding DL CC is determined to have been received from an eNB, the UE may activate the corresponding DL CC in the activation mode in operation 720. In operation 715, the UE may receive a DL CC deactivation instruction message from an eNB and deactivate the corresponding DL CC. Further, the UE may not receive a DL CC activation instruction message from an eNB, and the UE may maintain the DL CC in the deactivation state in operation 760.

If, as a result of the determination in operation 715, a DL CC deactivation instruction message is received, the UE maintains a deactivation mode in operation 760. Here, a CC of a deactivation mode may continue to maintain the deactivation mode in response to an activation instruction message, or a CC of the activation mode may be deactivated to a deactivation mode in response to a deactivation instruction message.

The UE activates a corresponding CC in response to the received activation instruction message in operation 720.

The reception of the activation message for a corresponding DL CC from an eNB in operation 715 may include a case in which the UE receives an L1 signaling, such as a physical control channel, a case in which the UE receives an L2 signaling or message, such as an MAC element, and a case in which the UE receives an L3 message, such as an RRC message.

The UE can acquire information, represented by 1 bit for each CC, from the activation instruction message. The UE can check whether each of the CCs represented by a piece of the set information is activated on the basis of the activation instruction message. For example, in the case in which a CC1 and a CC3 are in the activation mode and a CC2 is in the deactivation mode, the set information may represent the CC1 and the CC3, i.e., activated CCs. Furthermore, the UE may check whether each of the CCs is activated using the existing signaling, for example, according to whether control information exists in a physical channel, such as a PDCCH, without using a specific activation instruction message.

The UE checks activation instruction information that can be represented as described above in operation 715 and activates a corresponding CC in operation 720.

The UE determines whether data is received in operation 725 after the corresponding CC is activated. If, as a result of the determination in operation 725, data is determined not to be received, the UE receives the data in operation 730.

In operation 730, the UE receives the data through activated CCs. The UE determines whether there is a UL transmission permission message in the received data in operation 735. If, as a result of the determination in operation 735, the UL transmission permission message is determined not to exist, the UE receives the data as in operation 730, i.e., returns to operation 730. Meanwhile, in operation 735, in the case in which the UE transmits data through a UL CC linked to the corresponding DL CC, an eNB transmits UL resource allocation information to the UE through the existing activated CCs. The UE may receive the UL resource allocation information from the eNB and transmit data in the UL.

Accordingly, the UE determines whether a DL CC linked to an UL CC is in the activation mode in operation 740.

If, as a result of the determination in operation 740, the DL CC linked to the UL CC is determined not to be in the activation mode, the UE activates the corresponding DL CC in operation 745. Meanwhile, if, as a result of the determination in operation 740, the DL CC linked to the UL CC is determined to be in the activation mode, the UE returns to operation 730.

In other words, in the case in which the UE can transmit data through UL, ACK/NACK information on the sent data is transmitted through the DL CC linked to the UL CC. If the DL CC is operated in the DRX mode as in operation 740, the ACK/NACK information cannot be received. In this case, the UE switches the DRX mode of the DL CC to an NRX mode in operation 745, receives the ACK/NACK information through the activated DL CC in the NRX mode in operation 750, and then switches the mode of the DL CC to the DRX mode again within a predetermined time in operation 755.

In other words, the UE may switch a linked and deactivated DL CC to the NRX mode at a point of time at which the data is transmitted through the UL CC. The UE may switch the DL CC to the NRX mode at a point of time or earlier at which a response can be received from an eNB by taking the point of time at which the data is transmitted through the UL CC into consideration. As described above, the switch between the DRX mode and the NRX mode of the UE in order to receive the ACK/NACK information may be independently performed for every CC or may be performed at once in all CCs.

In the case in which there is a need for measurement (CQI, etc.) for a corresponding DL CC, i.e., in the case in which measurement is required in a predetermined cycle based on system information or at the request of an eNB, the UE may activate the corresponding DL CC without an activation or deactivation instruction message.

In the case in which the UE knows that system information is transmitted for a predetermined period through the corresponding DL CC and is to receive system information, i.e., in the case in which the UE is to receive information for determining the validity of system information or the validity of system information has expired and activation conditions have not been satisfied for a predetermined period after the corresponding DL CC is configured, the UE may activate the corresponding DL CC without activation and deactivation instruction messages from an eNB.

Meanwhile, if, as a result of the determination in operation 725, data is determined not to be received through an activated DL CC, the UE may check a DRX mode start condition in operation 765 and define the DRX mode in a corresponding CC in operation 770 if the start condition is satisfied. The UE may perform the DRX mode as follows in operation 770.

e-1) After the data is received through a corresponding DL CC, the UE may perform the DRX mode if a DRX-inactivity timer defined in DRX expires.

e-2) After the data is received through a corresponding DL CC, the UE may perform the DRX mode in synchronization with the same on-duration as a DRX mode applied to a reference CC. Here, the reference CC may be a CC that is a reference for performing DRM on other CCs, and the on-durations of other CCs are synchronized with the on-duration of the reference CC. The reference CC may be differently determined for every UE. The reference CC may be fixed or time-varying. The reference CC may include a primary CC which is configured in the UE. If a plurality of CCs is configured in a UE, one of CCs may be determined as the reference CC. This may be arbitrarily determined by a UE or may be determined by an eNB.

If all activated CCs do not perform the DRX mode, a UE may start the DRX mode if a DRX-inactivity timer defined in DRX for every CC expires, start the DRX mode according to the DRX setting of a reference CC, or start the DRX mode on the basis of DRX configuration information individually applied to a corresponding CC.

The UE may check the reception of data during the on-duration while performing the DRX mode in operation 775. If the reception of the data is received in operation 780, the UE stops the DRX mode in operation 790 and returns to operation 730 in which the data is received.

However, if there is no reception of data in operation 780, the UE determines whether the active timer has expired in operation 782. If, as a result of the determination in operation 782, the active timer according to the activation instruction message is determined to have expired, the UE deactivates the activated CC in operation 784. Meanwhile, if, as a result of the determination in operation 782, the active timer is determined not to have expired, the UE returns to operation 775.

If at least one of the following conditions is satisfied, the UE may configure a corresponding DL CC in the deactivation mode in operations 755 and 782.

The reception of the deactivation message for the corresponding DL CC from the eNB corresponds to a case in which the UE has received deactivation message for the corresponding DL CC from the eNB. The case may include a case in which the UE receives an L1 signaling, such as a physical control channel, a case in which the UE receives an L2 signaling or message, such as an MAC element, and a case in which the UE receives an L3 message, such as an RRC message. Here, the UE can acquire information, represented by 1 bit for each CC, from the deactivation instruction message.

The UE can check whether each of the CCs represented by a piece of the set information is deactivated from the deactivation instruction message. For example, if a CC1 and a CC3 are in the deactivation mode and a CC2 is the activation mode, the set information may represent the CC1 and the CC3, i.e., deactivated CCs. Furthermore, the UE may check whether each of the CCs is deactivated using the existing signaling, for example, according to whether control information exists in a physical channel, such as a PDCCH, without using a specific deactivation instruction message. Thus, the UE deactivates a corresponding CC by checking deactivation instruction information that can be represented as described above in operation 720. The UE may deactivate a corresponding DL CC in the case in which the DRX mode continues to be performed for a predetermined period or more, in the case in which measurement (CQI, etc.) for the corresponding DL CC is completed, in the case in which system information on which the corresponding DL CC is transmitted for a predetermined period is received, in the case in which deactivation conditions have not been satisfied for a predetermined time after the corresponding DL CC is activated, and the like.

In other words, a UE may activate a corresponding DL CC by checking a received activation instruction message and then perform a DRX mode for a predetermined period by checking whether data is transmitted through the corresponding DL CC.

In this case, the DRX mode for each CC may be performed on the basis of common DRX configuration information received from an eNB.

The UE may identically maintain a DRX start time for each CC on the basis of the received common DRX configuration information or may apply a different DRX start time to each CC. Here, the UE may use the received common DRX configuration information, but perform the DRX mode on a CC which is activated during a DRX period (T_DRX-in-act), determined when there is at least one activated reference CC, and is not used to receive data, according to the activation mode of each CC.

In other words, as shown in FIG. 7a and FIG. 7b, a UE configures all CCs based on received CC set information and sets the CCs in the deactivation mode, but adjusts the activation or deactivation mode of a corresponding CC according to a specific instruction and condition, such as the reception of the activation message for the corresponding CC. If one or more reference CCs, from among the CCs configured in the UE, are activated at a specific point of time, the UE performs a DRX mode only in the period in which data is not received within the activation period. Accordingly, in FIG. 7a and FIG. 7b, if all the CCs configured in the UE are deactivated, the UE does not perform the DRX mode.

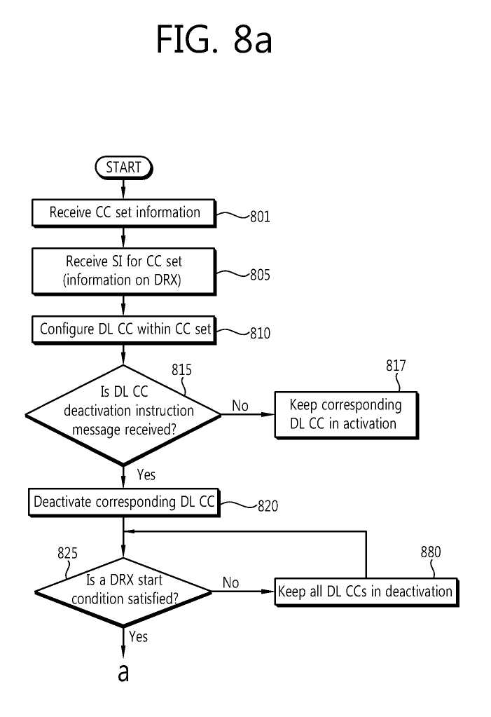

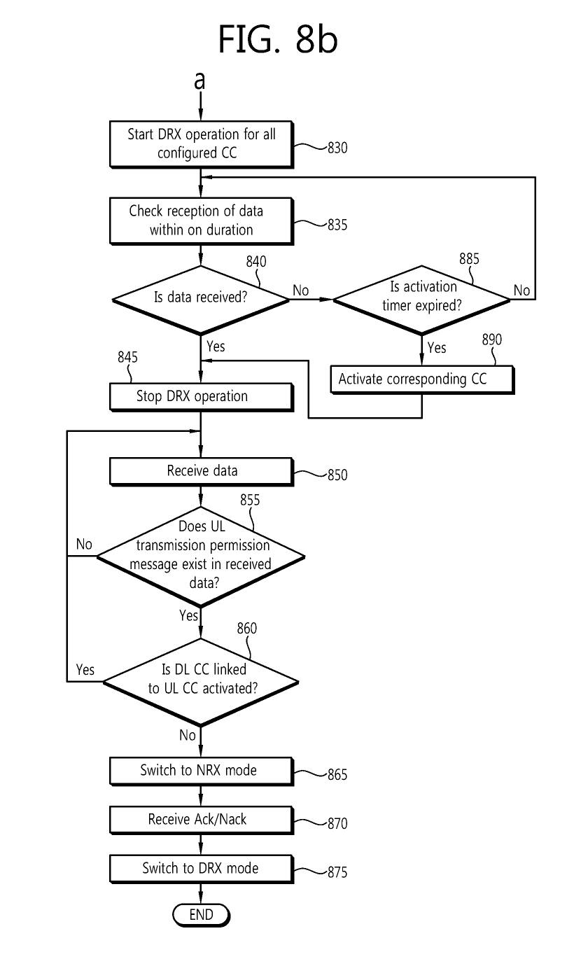

FIGS. 8a and 8b are a flowchart illustrating a method for activating a CC according to an exemplary embodiment. The method of FIGS. 8a and 8b correspond to a case in which a UE operates in the DRX mode on an activated CC.

Referring to FIG. 8a and FIG. 8b, the method in which a CC activation mode is taken into consideration includes a process of a UE receiving an activation message or a deactivation message for at least one CC and a process of the UE not performing the DRX operation if at least one CC is in the activation mode on the basis of the activation message or the deactivation message. The method may include the following; however, aspects are not limited thereto.

First, in operation 801, the UE receives information on a plurality of CCs permitted or allocated to the UE, from an eNB according to the performance of hardware of the UE and the construction of an apparatus thereof, the QoS requirements of an application program, and the like. A plurality of the allocated CCs may be defined as one CC set.

Here, an RRC connection mode between the eNB and the UE is the RRC_connected mode. That is, the UE is in a state in which the UE can perform transmission and reception for the RRC connection using at least one DL CC and one UL CC. Meanwhile, the DL CC used upon the RRC connection is activated until the DL CC is deactivated by a deactivation message or other conditions.

Information on a CC set of the UE may be sent to the UE through an RRC message. Other messages may be used to transmit the CC set information to the UE. The following conditions for defining a CC set may be used according to aspects of the present invention; however, the conditions are not limited to the following such that other conditions may be applied.

a-1) Conditions on the performance of hardware and the construction of an apparatus: the number of antennas, the range of a reception frequency, the capacity of memory, the number of maximum operating clocks, and the like.

a-2) The QoS requirements of an application program: VoIP, video streaming service, file transmission, web surfing, and the like.

a-3) Others: the amount of power consumption, user location information, a shadow region, a frequency selective channel, and the like.

On the other hand, if an RRC connection mode between the eNB and the UE is in the idle mode or if the RRC connection may be reset, the eNB may not define a CC set for the UE and transmit the CC set. Accordingly, the eNB selects at least one CC on which the RRC connection will be performed by selecting one of the following methods and configures CC set information; however, aspects are not limited hereto such that other methods may be used to select the CC on which the RRC connection will be performed.

b-1) A method for selecting a CC most appropriate to attempt the RRC connection on the basis of measured information.

b-2) A method using information stored in the internal memory of the UE and fixedly set or stored in a system.

b-3) A method using information transmitted from the eNB to the UE through system information.

b-4) A method using system information on valid CCs stored in the internal memory of the UE.

If the RRC connection is completed and the RRC connection mode between the eNB and the UE becomes the RRC_connected mode, the receiving of the CC set information operation 801 is started again.

The UE receives system information (SI) about CCs within the CC set other than CCs used to set the RRC connection on the basis of the received CC set information in operation 805. The system information includes information related to the DRX mode.

If there is a CC through which system information cannot be sent from among the CCs of the CC set, one of the following schemes may be selected and a procedure may be performed based on the selected scheme; however, aspects are not limited hereto such a different scheme may be applied. The CC may include an ECC (extension component carrier) or other CC type.

c-1) A scheme for receiving information, transmitted in a system information transmission format, through a CC from which system information can be received.

c-2) A scheme for receiving system information, converted into a control information form, through a CC from which control information can be received.

The UE configures each of the CCs in order to receive information through the DL CCs of the CC set on the basis of the received system information in operation 810. After the configuration is completed, the UE sets the corresponding CC in the deactivation mode.

The UE determines whether a DL CC deactivation instruction message is received in operation 815.

The UE may continue to maintain a CC in the activation mode in operation 817 according to the deactivation instruction message is not received (no operation in 815).

If, as a result of the determination, the deactivation message for a corresponding DL CC is determined to have been received from an eNB, the UE keeps the deactivation mode in 820. That is, the UE may change a CC in the activation mode to the deactivation mode in response to the deactivation instruction message in 820 and keep deactivation state the corresponding CC in response to the received deactivation instruction message in operation 820.

The reception of the deactivation message for the corresponding DL CC from the eNB in operation 815 may include a case in which the UE receives an L1 signaling, such as a physical control channel, a case in which the UE receives an L2 signaling or message, such as an MAC element, and a case in which the UE receives an L3 message, such as an RRC message. Here, the UE can acquire information, represented by 1 bit for each CC, from the deactivation instruction message. The UE can check whether each of the CCs represented by a piece of the set information is activated from the activation instruction message. For example, if a CC1 and a CC3 are in the activation mode and a CC2 is a deactivation mode, the set information may represent the CC1 and the CC3, i.e., activated CCs. The UE may check whether a CC is activated using the existing signaling, for example, according to whether control information exists in a physical channel, such as a PDCCH, without using a specific activation instruction message.

The UE checks the deactivation instruction information that can be represented as described above in operation 820 and deactivates the corresponding CC if the CC was in the active mode.

If the deactivation instruction message is checked in operation 815, the UE maintains the deactivation mode in operation 817 if the CC was in the deactivated mode.

Next, if all the CCs of the CC set are configured and have been deactivated, the UE determines whether at least one condition is satisfied to perform a DRX mode in operation 825.

Conditions for the DRX mode in operation 825 are as follows. If the following conditions are satisfied in operation 825, the UE may perform the DRX mode; however, aspects are not limited hereto such that other conditions may be applied or each condition need not be satisfied.

f-1) The DRX mode for all the deactivated CCs can be started according to the DRX setting of a corresponding CC (e.g., a CC RRC-connected, a special cell, a primary CC, or an anchor CC).

f-2) If a DRX-inactivity timer defined in DRX information on a finally deactivated CC expires, the DRX mode can be started.

If all the CCs of the CC set are configured, but the conditions f-1) and f-2) have not been satisfied in operation 825, the UE may maintain all the DL CCs in the deactivation mode in operation 880.

As shown in FIG. 8b, operation 830, the UE starts the DRX mode for all the configured CCs if the DRX start conditions are satisfied. Next, the UE may check the reception of data during an on-duration in operation 835 while performing the DRX mode in operation 830. If it is determined that data has been received in operation 840, the UE stops the DRX mode in operation 845 and receives the data in operation 850.

The UE determines whether an UL transmission permission message exists in the received data in operation 855. If, as a result of the determination, the UL transmission permission message is determined not to exist in the received data in operation 855, the UE returns to operation 850.

However, if, as a result of the determination in operation 855, the UL transmission permission message is determined to exist in the received data, the UE transmits data through an UL CC linked to the corresponding DL CC and determines whether the DRX mode is applied to the DL CC linked to the UL CC in operation 860.

If, as a result of the determination in operation 860, the DL CC linked to the UL CC is operated in the DRX mode, the UE switches the DL CC to the NRX mode in operation 865. Meanwhile, if it is determined in operation 860 that the DL CC linked to the UL CC is operated in the NRX mode, the UE returns to operation 850.

That is, if the UE can transmit data through UL, ACK/NACK information on the transmitted data is sent through the DL CC linked to the UL CC. If the DL CC is operated in the DRX mode, i.e., No of operation 860, the UE cannot receive the ACK/NACK information, and thus switches the DL CC to the NRX mode in order to receive the ACK/NACK information in operation 865. Next, the UE receives the ACK/NACK information through the DL CC for the UL transmission in operation 870 and switches the DL CC to the DRX mode again within a predetermined time in operation 875.

In the case where there is a need for measurement (CQI, etc.) for a corresponding DL CC, i.e., in the case in which measurement is required in a predetermined cycle based on system information or at the request of an eNB, the UE may activate the corresponding DL CC without activation and deactivation instruction messages. Further, in the case in which the UE knows that system information is transmitted for a predetermined period through the corresponding DL CC and may receive system information, i.e., in the case in which the UE receives information for determining the validity of system information or the validity of system information has expired and activation conditions have not been satisfied for a predetermined period after the corresponding DL CC is configured, the UE may activate the corresponding DL CC without activation and deactivation instruction messages from an eNB.

Meanwhile, if there is no reception of data in operation 840, the UE determines whether an inactive timer has expired in operation 885. If, as a result of the determination in operation 885, the inactive timer according to the deactivation instruction message is determined to have expired, the UE activates a corresponding deactivated CC in operation 890. If, as a result of the determination in operation 885, the inactive timer according to the deactivation instruction message is determined not to have expired, the UE returns to operation 835.

According to aspects of the invention, if at least one of the following conditions is satisfied, the UE may set a corresponding DL CC in the deactivation mode in operations 820 and 870.

The reception of the deactivation message for the corresponding DL CC from the eNB corresponds to a case in which the UE has received a deactivation message for the corresponding DL CC from the eNB. The above case may include a case in which the UE receives an L1 signaling, such as a physical control channel, a case in which the UE receives an L2 signaling or message, such as an MAC element, and a case in which the UE receives an L3 message, such as an RRC message.

Here, the UE can acquire information, represented by 1 bit for each CC, from the deactivation instruction message. The UE can check whether each of the CCs represented by a piece of the set information is deactivated from the deactivation instruction message. For example, if a CC1 and a CC3 are in the deactivation mode and a CC2 is the activation mode, the deactivation set information may represent the CC1 and the CC3, i.e., deactivated CCs. The UE may check whether a CC is deactivated using the existing signaling, for example, according to whether control information exists in a physical channel, such as a PDCCH, without using a specific activation instruction message.

Accordingly, the UE checks deactivation instruction information that can be represented as described above and deactivates a corresponding CC as in operation 820. Furthermore, the UE may deactivate the corresponding DL CC in the case in which the reception of data is not started or restarted for a predetermined time after the reception of the data is completed through the corresponding DL CC. Here, for example, the UE can check whether the reception of data is restarted for a predetermined time using a timer. For example, in the case in which measurement (CQI, etc.) for the corresponding DL CC is completed, in the case in which system information on which the corresponding DL CC is transmitted for a preset period is received, in the case in which activation conditions have not been satisfied for predetermined time after the corresponding DL CC is deactivated, and the like, the UE may deactivate the corresponding DL CC.

In other words, the UE may deactivate a corresponding DL CC in response to a received deactivation instruction message and perform the DRX mode until at least one of configured DL CCs is activated by checking whether all the DL CCs are deactivated. Furthermore, the UE may perform the DRX mode until the corresponding DL CC is switched to the RRC idle mode. Here, common DRX configuration information received from an eNB may be applied to the DRX mode for each CC.

The UE may apply the same DRX start time to the CCs on the basis of the received common DRX configuration information. Here, the UE may apply the received common DRX configuration information to the CCs, but may not perform the DRX mode if there is at least one activated CC in a DRX stop period T_no_DRX. That is, the UE may perform the DRX mode when all the CCs are deactivated in the DRX stop period T_no_DRX, 560 as shown in FIG. 5.

That is, in FIG. 8a and FIG. 8b, a UE may configure all CCs based on received CC set information and may set the CCs in the deactivation mode, but adjust the activation or deactivation mode of a corresponding CC according to a specific condition, such as the reception of the activation message for the corresponding CC. The UE performs the DRX mode if all the CCs configured in the UE are deactivated at a specific point of time as in operation 825.

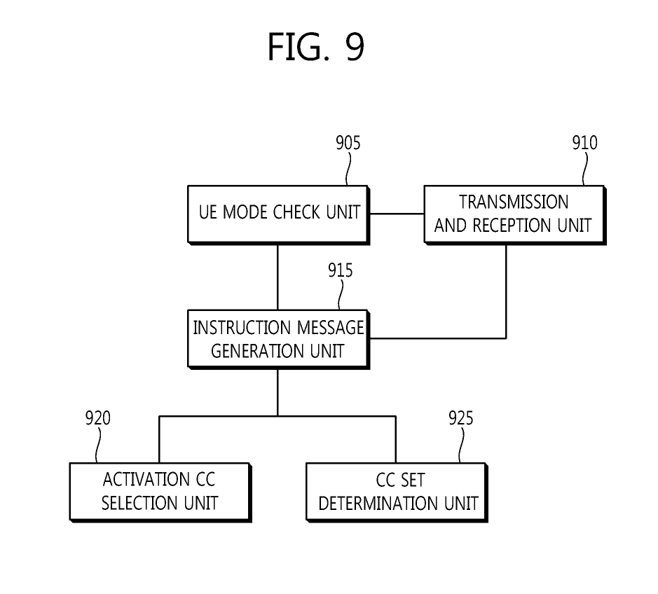

FIG. 9 is a block diagram of a transmission apparatus according to an exemplary embodiment of the present invention.

Referring to FIG. 9, an apparatus to transmit CC activation/deactivation messages includes an instruction message generation unit 915 to generate the activation or deactivation instruction message for one or more of a plurality of CCs and a transmission and reception unit 910 to transmit the generated activation or deactivation instruction messages to the UE. The apparatus may further include a UE mode check unit 905, an activation CC selection unit 920, and a CC set determination unit 925.

The apparatus to transmit the CC activation/deactivation messages may be implemented as an eNB apparatus, but aspects are not limited thereto. The apparatus may be implemented using separate hardware or software or both.

The UE mode check unit 905 checks whether an RRC connection is set up between an eNB and a UE. The UE mode check unit 905 checks the UE RRC connection state. An eNB transmits CC set information, system information for each CC, and activation/deactivation instruction messages to a UE. To this end, the RRC_connected mode may be set between the eNB and the UE. The UE mode check unit 905 checks whether a UE is in an RRC connection mode.

The activation CC selection unit 920 to determine a CC to be set as an activation CC, from among a plurality of CCs, or the state of the UE or selecting a CC which is now in the deactivation mode, but needs to be switched to the activation mode. The conditions for switching to the deactivation mode are the same as those described above with reference to FIGS. 6 to 8.

The instruction message generation unit 915 generates an activation message for the activation CC selected by the activation CC selection unit 920, and generates a deactivation message for a CC to be deactivated. The generated activation or deactivation message may be transmitted to a UE through an L1 signaling, such as a physical control channel, an L2 signaling, such as an MAC element, or an L3 signaling, such as an RRC message, via the transmission and reception unit 910.

The CC set determination unit 925 determines a CC set, i.e., a set of CCs that will be configured by a UE, from among a plurality of CCs, according to at least one of conditions for the performance of hardware and the construction of an apparatus: the number of antennas, the range of a reception frequency, the capacity of memory, the number of maximum operating clocks; the QoS requirements of an application program: VoIP, video streaming service, file transmission, and web surfing; and/or others: the amount of power consumption, user location information, a shadow region, and frequency selective channels. The CC set information may include the ID of a corresponding CC, index information on each CC, and offset information to indicate other CCs on the basis of at least one CC, which are included in the CC set, but not limited thereto.

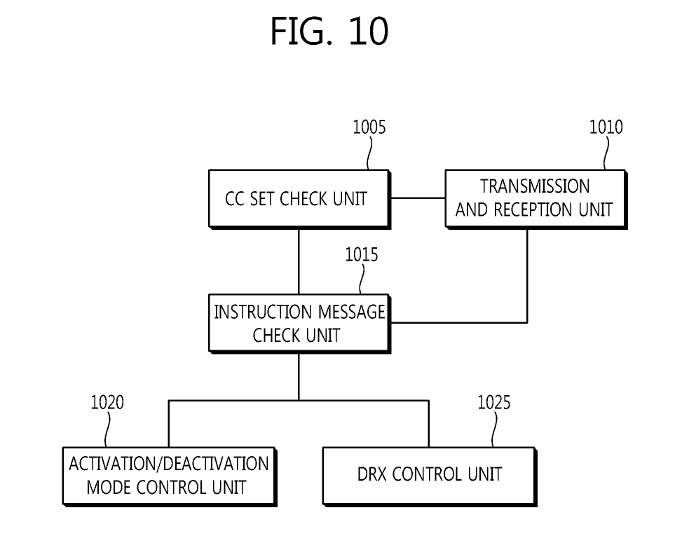

FIG. 10 is a block diagram of a reception (or DRX) apparatus according to an exemplary embodiment.

Referring to FIG. 10, the DRX apparatus includes an activation/deactivation mode control unit 1020 to receive the activation or deactivation message and to operate in the activation mode or the deactivation mode, and a DRX control unit 1025 to control the discontinuous (DRX) operation in response to the activation or deactivation message. The DRX apparatus may further include a CC set check unit 1005, an instruction message check unit 1015, and a transmission and reception unit 1010, but aspects are not limited thereto.

The transmission and reception unit 1010 may receive the activation or deactivation message for at least one of a plurality of CCs from an eNB or transmission apparatus. The transmission and reception unit 1010 may further receive CC set information and system information on a corresponding CC or the CCs). The transmission and reception unit 1010 may also receive common DRX configuration information. The common DRX configuration information may be included in the system information.

The DRX control unit 1025 controls the DRX mode of the DRX apparatus on the basis of the activation or deactivation message received from the transmission and reception unit 1010. The DRX control unit 1025 determines whether a condition for the application of the DRX mode to each of CCs is satisfied. If the condition for the application of the DRX mode to each of the CCs is satisfied, the DRX control unit 1025 performs the DRX mode on each of the CCs.

In an exemplary embodiment, the DRX control unit 1025 may perform the DRX mode even if a CC is in the activation mode.

In particular, the DRX control unit 1025 may adjust all the CCs to have the same timer length, the same start and end times of an active time, and the same DRX cycle in the DRX mode on the basis of the common DRX configuration information.

Assuming that each CC enters the DRX mode on the basis of the common DRX configuration information, a point of time at which the CC enters the DRX mode may differ. The DRX control unit 1025 may slightly delay or advance a point of time at which the first active times of other activated CCs so that the first active times are identical with the active time of a reference CC.

Although CCs enter the DRX mode at different points of time as described above, the active or inactive times of the DRX modes may be synchronized with each other, and the PDCCHs of all the CCs may be detected at the active times of the respective CCs. Accordingly, the power consumption of a UE can be reduced.

In an exemplary embodiment, if one CC or more are in the activation mode, the DRX control unit 1025 may control the DRX operation so that the DRX operation is not performed.

The DRX control unit 1025 may switch the reception mode of each CC to the DRX mode or the NRX mode according to whether downlink ACK/NACK information is received. The DRX control unit 1025 may switch each CC between the DRX mode and the NRX mode or may switch all CCs between the DRX mode and the NRX mode at the same time.

The CC set check unit 1005 receives CC set information, such as the ID of a corresponding CC, index information on each CC, and offset information to indicate other CCs on the basis of at least one CC, which are included in the CC set and checks CCs to be configured in a UE on the basis of the received CC set information.

The instruction message check unit 1015 checks the activation or deactivation message, received through an L1, L2, or L3 signaling, and the activation/deactivation mode control unit 1020 sets each CC in the activation mode or in the deactivation mode.

The DRX apparatus may be implemented in a UE, but aspects are not limited thereto. The DRX apparatus may be configured in an apparatus separate from a UE.

Although CCs enter the DRX mode at different points of time, the active or inactive times of the DRX modes are synchronized with each other, and then the PDCCHs of all the CCs may be detected at the active times of the respective CCs. Accordingly, the power consumption of a UE can be reduced.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for performing Discontinuous Reception (DRX) by a User Equipment (UE) in Component Carriers (CCs) system, the method comprising
determining whether a condition for an application of a DRX mode to a CC is satisfied; and
performing the DRX mode on the CC based on DRX configuration information common to the CC and a reference CC if the condition is satisfied,
wherein an on-duration of the DRX applied to the CC is synchronized with an on-duration of a DRX of the reference CC.

2. The method of claim 1, further comprising:
receiving an instruction message to activate the CC from an evolved Node-B (eNB); and
activating the CC to change Reception (NRX) mode from the DRX mode on the CC.

3. The method of claim 1, wherein the reference CC is configured for the UE specific.

4. The method of claim 1, wherein the reference CC is a primary CC configured for the UE.

5. The method of claim 1, further comprising:
adjusting a DRX cycle of the CC to synchronize the on-duration of the CC with the on-duration of the reference CC.

6. The method of claim 1, further comprising:
receiving system information for the UE, wherein the system information comprises the DRX configuration information.

7. The method of claim 1, further comprising:
adjusting the DRX mode for at least one activated CC among the CCs according to the DRX configuration information.

8. The method of claim 1, further comprising:
if there is downlink acknowledgement (ACK)/non-acknowledgement (NACK) information to be transmitted through the reference CC or the CC, switching the reference CC or the CC to the Reception (NRX) mode; and
receiving the ACK/NACK information for the UL transmission via the CC.

9. An apparatus to perform a Discontinuous Reception (DRX) in a Component Carriers (CCs) system, the apparatus comprising:
a DRX control unit to determine whether a condition for an application of a DRX mode to a CC is satisfied and to perform the DRX mode on the CC based on DRX configuration information common to the CC and a reference CC if the condition is satisfied; and
a transmission and reception unit to receive the DRX configuration information,
wherein the DRX control unit synchronizes an on-duration of the CC with an on-duration of the reference CC.

10. The apparatus of claim 9, wherein:
the transmission and reception unit receives an instruction message from an evolved Node-B (eNB) to activate the CC, and
the DRX control unit activates the CC to change Reception (NRX) mode from the DRX mode on the CC.

11. The apparatus of claim 9, wherein the reference CC is configured for the UE specific.

12. The apparatus of claim 9, wherein the reference CC is a primary CC configured for the UE.

13. The apparatus of claim 9, wherein the DRX control unit adjusts a DRX cycle of the CC to synchronize the on-duration of the CC with the on-duration of the reference CC.

14. The apparatus of claim 9, wherein the transmission and reception unit receives the DRX configuration information through system information.

15. The apparatus of claim 9, wherein the DRX control unit switches the DRX mode for at least one activated CC among the CCs according to the DRX configuration information.

16. The apparatus of claim 9, further comprising:
a CC set check unit to receive CC set information and to check CCs to be configured according to the received CC set information.

17. The apparatus of claim 9, further comprising:
an instruction message check unit to check whether the instruction message is an activation or deactivation message; and
an activation/deactivation mode control unit to set each CC in an activation mode or in a deactivation mode according to the checked activation or deactivation message.

18. An apparatus to transmit activation/deactivation information in Component Carriers (CCs) system, the apparatus comprising:
an instruction message generation unit to generate an activation or deactivation instruction message for one or more of a plurality of CCs according to a condition for a DRX operation in of a User Equipment (UE);
a transmission and reception unit to transmit the generated activation or deactivation instruction message to the UE;
a UE mode check unit to check whether a Radio Resource Control (RRC) connection is set up with the UE;
an activation CC selection unit to determine a CC to be set as an activation CC from among the plurality of CCs; and
a CC set determination unit to determine a set of CCs from the plurality of CCs to be configured by the UE.

19. A method for performing Discontinuous Reception (DRX) in a multi-Component Carrier (CC) system, the method comprising:
checking a Radio Resource Control (RRC) mode of a user equipment (UE);
configuring a CC set;
transmitting the configured CC set to the UE;
transmitting system information for the CC set to the UE;
selecting an activation CC according to CC activation requirements;
checking a CC operating in the activation mode from the deactivation mode, generating an activation instruction message, and transmitting the activation instruction message to the UE; and
checking a CC operating in the deactivation mode from the activation mode, generating a deactivation instruction message, and transmitting the deactivation instruction message to the UE.

20. The method of claim 19, wherein the checking a CC operating in the activation mode from the deactivation mode and the checking a CC operating in the deactivation mode from the activation mode are performed at a same time.
